(19) United States
(12) Patent Application Publication
(10) Pub. No.: US 2012/0222024 A1
(43) Pub. Date: Aug. 30, 2012

(54) Mechanism for Managing Support Criteria-Based Application Binary Interface/Application Programming Interface Differences

(76) Inventor: Kushal Das, West Bengal (IN)

(21) Appl. No.: 13/034,544

(22) Filed: Feb. 24, 2011

(51) Int. Cl. G06F 9/44

(52) U.S. Cl. 717/170

(57) ABSTRACT

A method for maintaining support criteria-based application binary interface/application programming interface differences is described. The method may include extracting binary files relating to a plurality of versions of a software program. The binary files include support criteria associated with shared libraries used by the plurality of versions of the software program. The method may further include detecting interfaces associated with the shared libraries. The method may further include marking the detected interfaces based on their corresponding support criteria. The interfaces include first interfaces associated with a first version of the plurality of versions, and second interfaces associated with a second version of the plurality of versions. The method may further include examining interface differences between the first and second interfaces.

### TECHNICAL FILED

The embodiments of the invention relate generally to software compatibility and, more specifically, relate to providing a mechanism for managing application binary interface/application programming interface differences that are based on their respective support criteria.

### BACKGROUND

Multiple software programs that run on a computing device often share libraries provided by the base operating system employed at the computing device. For example, these libraries can be used by the software programs to access various library or operating system functions (e.g., reading files, writing files, file management, network communications, inter-process communications, memory management, string manipulations, user interface manipulations, mathematics functions, etc.). Typically, these shared libraries change when the operating system changes or is updated; for example, upgrading to a newer version of an operating system can change functions presented in one or more shared libraries, versions and arguments used in these functions, and/or functionalities of some, none or all of the library functions. As a result, a software program developed for one operating system may not work on another operating system and, similarly, upgrading to a newer version of an operating system may cause a software program not to work on the new or updated operating system. To determine whether a software program is executable on a new or updated operating system, the software program is typically re-compiled to run on the new or updated operating system.

The aforementioned re-compiling and re-running of the software program is further complicated when multiple software programs are involved. These multiple software programs may include customer-generated software programs (e.g., third-party software programs that are created and provided by organizations or sources independent of the one providing the base operating system and shared libraries). Furthermore, a user (e.g., software developer, system administrator, etc.) remains unaware as to which of the shared libraries are important to the multiple third-party software programs running on the operating system; consequently, by updating a shared library provided by the base operating system, the user risks breaking existing software and adding to inefficiency by wasting system resources.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a host machine employing an application binary interface/application programming interface difference management mechanism according to one embodiment of the invention;

FIG. 2 illustrates an application binary interface/application programming interface difference management mechanism according to one embodiment of the invention;

FIG. 3 illustrates a method for performing application binary interface/application programming interface difference management according to one embodiment of the invention; and

FIG. 4 illustrates a computing system according to one embodiment of the invention.

### DETAILED DESCRIPTION

Embodiments of the invention provide a mechanism for maintaining support criteria-based application binary interface/application programming interface differences is described. A method of embodiments of the invention includes extracting binary files relating to a plurality of versions of a software program. The binary files include support criteria associated with shared libraries used by the plurality of versions of the software program. The method further includes detecting interfaces associated with the shared libraries. The process of detecting is performed by probing the binary files, and the interfaces include application binary interfaces. The method further includes marking the detected interfaces based on their corresponding support criteria. The interfaces include first interfaces associated with a first version of the plurality of versions, and second interfaces associated with a second version of the plurality of versions. The method further includes examining interface differences between the first and second interfaces by comparing the first interfaces with the second interfaces.

The embodiments of the present invention are provided for determining differences between application binary interfaces (“ABIs”) and/or application programming interfaces (“APIs”) of various releases or versions of a software entity based on their support criteria. In one embodiment, ABIs/APIs are marked according to their associated support criteria and then, the ABIs/APIs associated with the most recent version of the software entity are compared with ABIs/APIs of one or more previous versions of the software entity to detect differences between the recent and previous release(s) of the software entity. If there are ABI/API differences, a provider-based software developer can take advantage of these support criteria-based results to efficiently determine whether the differences are intentional or unintentional. Any of the differences based on intentional changes (e.g., due to an operating system function upgrade) are maintained, while those made in error are corrected. Since these acts are performed on the provider-end and prior to providing the most recent version of the software entity to customers, any potential problems on the customer-end are prevented.

As will be discussed throughout this document, a provider refers to a company or organization responsible for creating and providing a base operating system, local software programs, shared libraries, etc., while a customer refers to a third-party company or organization responsible for generating and providing third-party software programs that access and use the provider-based shared libraries and the associated interfaces (e.g., ABIs, APIs). Further, these shared libraries and the associated ABIs/APIs may be accessed and used by one or more local software programs that are part of the operating system and independent of the one or more third-party software programs. Embodiments of the invention are applicable to ABIs and/or APIs and as such the term “ABI(s)/API(s)”, used throughout this document, refers to ABI(s) and/or API(s).

An ABI represents a low-level interface between a software program and an operating system or another software program. An ABI represents a compiled binary form of an operating system function (function) serving as a low-level interface between local and third-party software programs and the base operating system. When a function is broken, such as a print function (e.g., when a print command executes double prints or does not print the entire text (e.g., prints “hell” when asked to print “hello”)), etc., the broken function indicates a possible problem with the corresponding ABI and the associated shared library. An API serves as an interface between various software programs and facilitates interaction between them, while representing a particular set of rules and specifications that a software program can follow to access and make use of the services and resources provided by another particular software program that implements that API. ABI/API refer to and may include data-identifying ABIs and/or APIs, such as those providing and covering details, such as data types, sizes, alignments, identification names and other unique identifications, symbol versions, system call numbers, binary format of object files, locations, versions, calling conversations, etc.

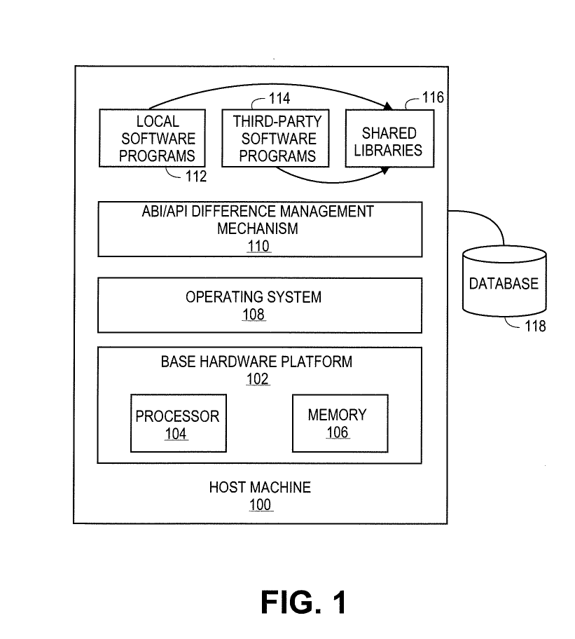

FIG. 1 illustrates a host machine 100 employing an ABI/API difference management mechanism 110 according to one embodiment of the invention. Host machine 100 includes a base hardware platform 102 that comprises a computing platform, which may be capable, for example, of working with a standard operating system 108. Operating system 108 serves as an interface between any hardware or physical resources of the host machine 100 and a user (e.g., software developer, computer programmer, system administrator, etc.). In some embodiments, base hardware platform 102 may include a processor 104, memory devices 106, network devices, drivers, and so on. Host machine 100 may include a server computing system or a client computing system. Further, terms like “machine”, “device”, “computer”, and “computing system” are used interchangeably and synonymously throughout this document.

In one embodiment, the host machine 100 employs an ABI/API difference management mechanism 110 (“ABI/API difference mechanism”) to manage support criteria-based differences between ABIs/APIs associated with shared libraries 116 of multiple versions of a software entity (e.g., software programs 112, 114, operating system 108, etc.). In one embodiment, ABI/API difference mechanism 110 extracts binary files of various versions (e.g., including the most recent version and one or more previous versions, as necessitated or desired) of a software entity. Once extracted, the ABI/API difference mechanism 110 detects and marks each ABI/API of each version based on the support criteria associated with it. The marked ABIs/APIs are then examined by the ABI/API difference mechanism 110 by, for example, comparing the ABIs/APIs of the most recent version of the software entity (e.g., version 3.0 that is not yet released to customers) with the ABIs/APIs of a previous version of the same software entity (e.g., version 2.0 that has been released to customers) to detect differences between the ABIs/APIs of the two versions. This is so that any ABI/API differences caused in error can be corrected by the provider prior to releasing the most recent version of the software entity to its potential customers. Examples of versions or releases of software entities include Red Hat Enterprise Linux 2.1, 3, 4, etc., Windows® 2000, XP, 7, etc., shared library libgtk 1, 2, 3, 4, etc., and the like.

For example, if an ABI/API (e.g., relating to a delete function) of a shared library 116 (e.g., libgtk) of the latest unreleased version (e.g., version 3.0) of the software entity is found to be different from the same ABI/API of the latest released version (e.g., version 2.0) of the software entity, then the difference is examined to, first, determine whether the difference was caused by a change made in error and, second, fix the difference if it was caused by an error. Given the ABIs/APIs are marked based on their respective support criteria (e.g., version 3.0 support criteria versus version 2.0 support criteria), the determination of whether the detected ABI/API difference was intended or made in error is performed automatically based on the differences found between their respective support criteria. For example, if a function upgrade (e.g., print function upgrade) is provided in the version 3.0-based support criteria, a difference between the print-based ABI/API of the version 3.0-based support criteria and the print-based ABI/API of the version 2.0-based support criteria would be expected and regarded intentional. Conversely, absent any support criteria-based changes, any differences detected between the two relevant ABIs/APIs of the two versions may be regarded as errors.

If the difference is determined to be due to a change made in error (e.g., human error), a provider-based software developer may fix the error so that the customers can be prevented from encountering potential error-related problems. If, however, the difference is determined to be based on an intentional change (e.g., overall change made in the support criteria for a customer, a newly added or updated function, such as adding an ability to recover deleted items, etc.), the ABI/API difference is maintained and any potential customers are notified to anticipate the difference in the most recent version so any necessary changes (e.g., changes to the customer-based system or relevant software applications) can be made on the customer-end to accommodate the anticipated ABI/API difference.

In one embodiment, all ABIs/APIs of the latest unreleased version, e.g., version 3.0, of the software entity are compared with all ABIs/APIs of the latest released version, e.g., version 2.0, of the software entity to determine whether there have been any changes in the total number of ABIs/APIs. Any change in the total number of ABIs/APIs between the two versions of the software entity may also be regarded as an ABI/API difference. In this case, a report is generated and provided to a provider-based software developer. When possible, the report may be sent to the same software developer who developed the software entity so they may review the report and correct any unintentional differences, and maintain any intentional differences, as discussed above. In one embodiment, any relevant information about the original software developer may be obtained from the extracted binary file relating to the software entity.

In one embodiment, the binary file includes an actual software program code of the software entity, time and date the software entity was developed, name of the software developer(s) involved in developing the software entity, details of support criteria relating to the software entity, and other information, such as ABI/API provisioning details (including a list of ABIs and APIs associated with shared libraries and their associated metadata), and ABI/API usage details of ABIs/APIs indicating the usage frequency by which each ABI and/or APIs is accessed and used by the software entity.

ABI/API provisioning and usage details may be used to determine priority levels of various shared libraries 116, while the priority levels may be used to establish and assign support criteria to each ABI/API associated with each shared library 116, such as to provide a high level of customer support for a shared library 116 that has a high priority level-based support criteria as opposed to the one that is assigned a lower priority level-based support criteria. The provider may use these support criteria to address its customers' requests based on their changing needs and thus, to provide better customer service.

ABI/API provisioning details may further include the number of ABIs/APIs associated with each shared library 116, the known use of such ABIs/APIs, various library or operating system functions associated with each ABI/API and the importance of each of those functions, etc. ABI/API usage details provide usage-frequency of each ABI/API to reflect its importance based on how frequently an ABI/API is accessed or used by, for example, a third-party software program 114. Although ABI/API usage details can indicate importance of an ABI/API based on its usage-frequency, a support criterion associated with that ABI/API may adjust that importance, up or down, based on a particular customer's changing needs. For example, a prominent shared library, such as glibc/libc.so.6, provides a popular function ABI, such as strcmp, which can be found in several applications and thus can be significantly important due to its high usage, but it may not be as important to a particular customer and that would be reflected in the support criteria formed for that customer and associated with the shared library and the ABI.

Examples of functions associated with ABIs/APIs and their shared libraries 116 include reading files, writing files, deleting files, file management, network communications, inter-process communications, memory management, string manipulations, user interface manipulations, mathematics functions, or the like. Further, shared libraries 116 and their ABIs/APIs may be accessed and used by one or more third-party software programs 114, one or more local software programs (including, but not limited to, local software programs 112) that are part of (and/or provided by the same host or provider that provides) the operating system 108 and independent of the one or more third-party software programs 114.

A shared library 116 represents a collection of classes and subroutines that are used to develop and support software programs, such as representing code and data that provide services to both local and other independent software programs 112, 114. For example, an operating system 108 may provide shared libraries 116 to implement aforementioned functions that are used by various local and third-party software programs 112, 114. Other libraries may be provided by and specific to third-party software programs 114 created and provided by third-party providers (e.g., a third-party software development company or organization other than the provider responsible for creating and providing the operating system 108 and the shared libraries 116). Each shared library 116 provides a collection or group of ABIs/APIs.

As aforementioned, a third-party or customer software program 114 represents a software program that is, at least partly, developed by an organization other than the provider that produces the operating system 108 and the shared libraries 116. For example, a third-party software program 114 may include a special-purpose software program that is used for or by an organization (e.g., media development software for media companies, specialized modeling software, etc.) and, like a local software program 112, accesses and uses any number of shared libraries 116 to utilize various functions.

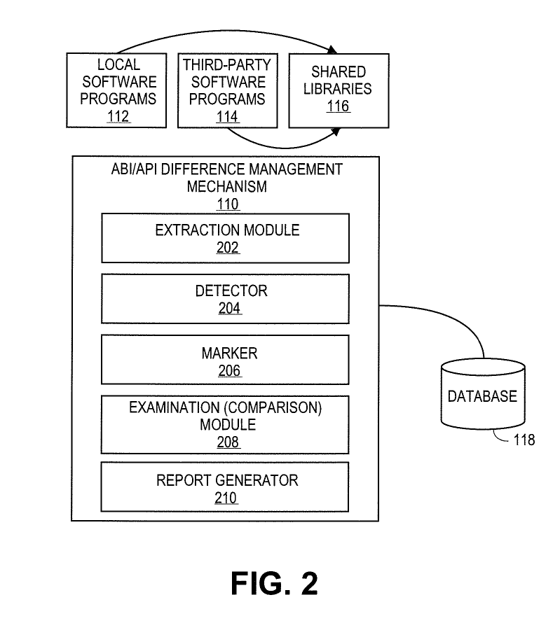

FIG. 2 illustrates an API/API difference management mechanism 110 according to one embodiment of the invention. In one embodiment, the ABI/API difference mechanism 110 includes an extraction module 202 to extract binary files of various versions of a software entity (e.g., software programs 112, 114) to detect and examine their associated shared libraries 116 and their ABIs/APIs for managing ABI/API differences. A binary file may include binaries, compiled software program code, object files, ABI/API provisioning details, ABI/API usage details, and other relevant information, such as time and date when a software entity was developed, name of the software developer responsible for developing the software entity, etc. ABI/API difference mechanism 110 further includes a detector 204 to detect the ABIs/APIs from the binary files for each version (e.g., the most recent unreleased version and at least one previous released version) of the software entity. The detector 204, in one embodiment, uses a library controller or installer to monitor or scan through the extracted binary files to find ABIs, APIs, support criteria, etc. In one embodiment, the binary files may be extracted from a database 118.

In one embodiment, the detected ABIs/APIs are then marked by a marker 206 of the ABI/API difference mechanism 110 for each version based on its corresponding support criteria. In one embodiment, the marked ABIs/APIs are then examined by an examination (comparison) module 208 of the ABI/API difference mechanism 110 based on their corresponding support criteria. The examination process, in one embodiment, includes a comparison of the marked ABIs/APIs of one version of the software entity (e.g., the most recent version that is unreleased to the customer) with the marked ABIs/APIs of a previous version (e.g., the last released version) to determine differences between them. As previously discussed, an ABI/API difference can be based on an intentional change to the software entity (e.g., a customer-requested change to the support criteria, adding a new function, etc.) or an unintentional change (e.g., an error made by the software developer, etc.). In one embodiment, unintentional differences are corrected by a provider-based software developer prior to releasing the most recent unreleased version to customers, while any intentional differences are maintained.

As an example, an unintentional difference may be caused when an ABI associated with a shared library 116 (e.g., g_quit_*, where * represents add, delete, etc., associated with shared library libgtk) is accidently or mistakenly changed or deleted by the software developer. For example, an accidental deletion of g_quit_add means removal of the add function and a change to the umbrella function, g_quit_*, as well as to the associated shared library 116 (e.g., libgtk). Since this change is made in error, it is not expected to be be supported by the support criteria and therefore, the change is detected when the recent ABIs/APIs are compared with the previous ABIs/APIs. By having the provider correct errors before releasing the latest version of the software entity to the customer, the customer is prevented from encountering any potential problems associated with the error. This can be particularly significant when an error can be large or significant enough that if left unfixed could temporarily paralyze a customer's system or software. With regard to intentional differences, potential customers are notified of such differences so they may upgrade the necessary components of their system and/or software, accordingly.

In one embodiment, ABI/API differences are determined based on the total number of ABIs/APIs. For example, using the examination module 208, a total count of ABIs/APIs of the most recent unreleased version is matched with a total count of ABIs/APIs of a previous version of the software entity. When the two counts are not found to be exact, a report is automatically generated, using the report generator 210, listing the unmatched ABIs/APIs. A user (e.g., provider-end software developer) may review the differences and decide to leave them or fix them depending on whether the differences were intentional or unintentional, respectively. The examination results are stored at the database 118 and provided as a report, generated by a reporting module 210, using any communication mode (e.g., email) and displayed on a display device in any display form (e.g., Portable Document Format (PDF), Open Document Format (ODF), text, graphs, charts, etc.) using, for example, a graphical user interface (GUI) application. The report may be provided to and used by providers and/or customers.

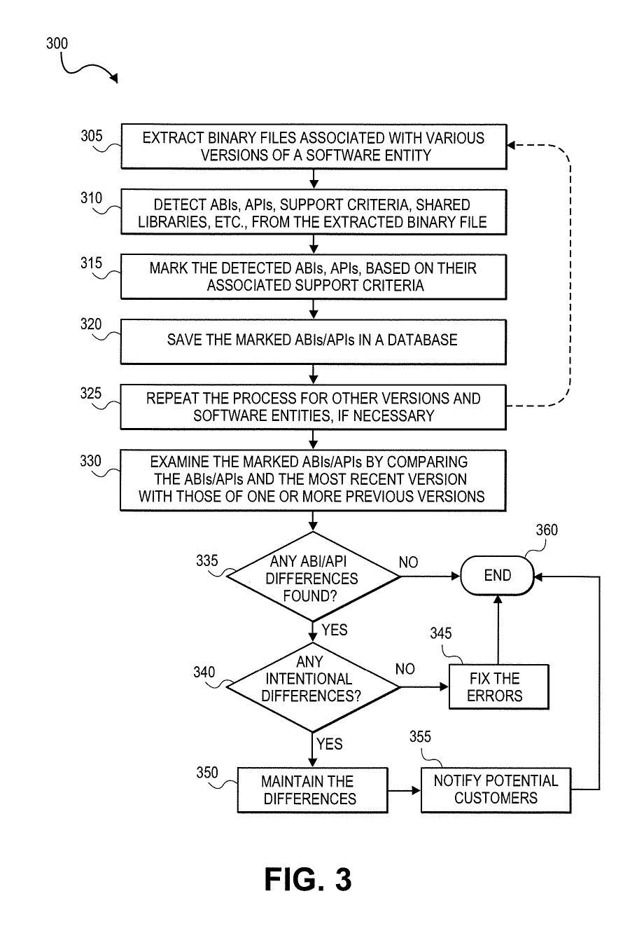

FIG. 3 illustrates a method for managing ABI/API differences according to one embodiment of the invention. Method 300 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 300 is performed by ABI/API difference management mechanism of FIG. 1.

Method 300 starts at block 305 with extracting binary files of various versions of a software entity (e.g., a software program, an operating system, etc.). The various versions may include the most recent version of the software entity that is not yet released to potential customers and one or more preceding versions. At block 310, the binary files are probed and certain details, such as ABIs/APIs and their associated shared libraries and support criteria, etc., are obtained from the binary files. At block 315, the detected ABIs/APIs are marked based on their associated support criteria. At block 320, the marked ABIs/APIs and other relevant information are saved in a database. At block 325, the process thus far may be repeated, starting with block 305, for additional versions and/or software entities.

At block 330, the marked ABIs/APIs are examined by having the marked ABIs/APIs of the most recent version of the software entity compared with those of one or more previous versions of the software entity. At decision block 335, a determination is made as to whether any ABI/API differences were detected. If not, the process ends at block 360. If yes, at block 340, a determination is made as to whether any of the ABI/API differences were intended. If not, the differences are regarded as errors and are fixed, at block 345, and the process ends at block 360. If yes, the intentional differences are maintained, at block 350, and the potential customers are notified to expect changes to their support criteria and the software entity based on these differences at block 355. The process ends at block 360.

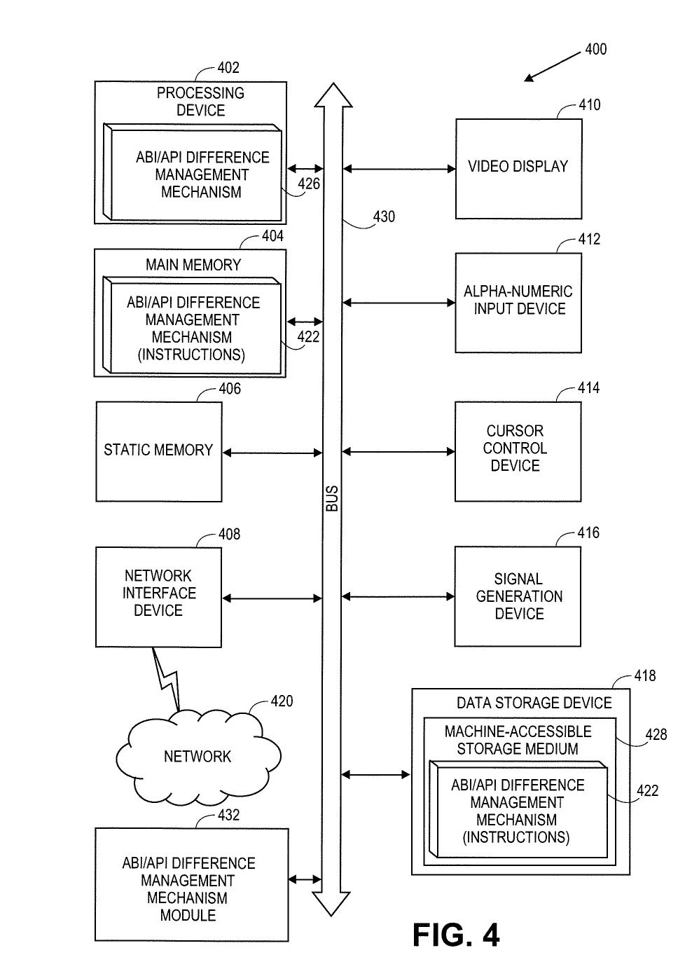

FIG. 4 illustrates a computing system 400 employing an ABI/API difference management mechanism according to one embodiment of the invention. Within the computing system 400 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computing system 400 includes a processing device 402, a main memory 404 (e.g., read-only memory (ROM), flash memory, RAM, dynamic RAM (DRAM) such as synchronous DRAM (SDRAM), DRAM (RDRAM), etc.), a static memory 406 (e.g., flash memory, static random access memory (SRAM), etc.), and a secondary memory 418 (e.g., a data storage device in the form of a drive unit, which may include fixed or removable machine-accessible or computer-readable storage medium), which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute the processing logic 426 for performing the operations and methods discussed herein.

The computing system 400 may further include a network interface device 408. The computing system 400 also may include a video display unit 410 (e.g., a liquid crystal display (LCD) or a cathode ray tube (CRT)) connected to the computing system through a graphics port and graphics chipset, an alphanumeric input device 412 (e.g., a keyboard), a cursor control device 414 (e.g., a mouse), and a signal generation device 416 (e.g., a speaker).

The data storage device 418 may include a machine-accessible storage medium (or a computer-readable storage medium) 428 on which is stored one or more sets of instructions 422 (e.g., API/API difference management mechanism) embodying any one or more of the methodologies or functions described herein. The API/API difference management mechanism may also reside, completely or at least partially, within the main memory 404 (e.g., API/API difference management mechanism (instructions) 422) and/or within the processing device 402 (e.g., API/API difference management mechanism (processing logic) 426) during execution thereof by the computing system 400, the main memory 404 and the processing device 402 also constituting machine-readable storage media. Further, for example, the API/API difference management mechanism instructions 422 may be transmitted or received over a network 420 via the network interface device 408.

The machine-readable storage medium 428 may also be used to store the API/API difference management mechanism (instructions) 422 persistently. While the machine-accessible storage medium 428 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

API/API difference management mechanism modules 432, components and other features described herein (for example in relation to FIG. 1) can be implemented as discrete hardware components or integrated in the functionality of hardware components such as ASICS, FPGAs, DSPs or similar devices. In addition, the modules 432 can be implemented as firmware or functional circuitry within hardware devices. Further, the modules 432 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “extracting”, “detecting”, “marking”, “repeating”, examining“, “comparing”, “analyzing”, “generating”, “saving”, “storing”, “obtaining”, “scanning”, “monitoring”, “communicating”, “accessing”, “providing”, “facilitating”, “maintaining”, “notifying”, “fixing”, “correcting” or the like, refer to the action and processes of a computing system, or similar electronic computing device, that manipulates and transforms data represented as physical (electronic) quantities within the computing system's registers and memories into other data similarly represented as physical quantities within the computing system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including floppy disks, optical disks, magnetic-optical disks, ROMs, compact disk ROMs (CD-ROMs), RAMs, erasable programmable ROMs (EPROMs), electrically EPROMs (EEPROMs), magnetic or optical cards, or any type of media suitable for storing electronic instructions, each coupled to a computing system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computing system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., ROM, RAM, magnetic disk storage media, optical storage media, flash memory devices, etc.), a machine (e.g., computer) readable transmission medium (non-propagating electrical, optical, or acoustical signals), etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method comprising:
extracting binary files relating to a plurality of versions of a software program, wherein the binary files include support criteria associated with shared libraries used by the plurality of versions of the software program;
detecting interfaces associated with the shared libraries, wherein detecting is performed by probing the binary files, wherein the interfaces include application binary interfaces (ABIs);
marking the detected interfaces based on their corresponding support criteria, wherein the interfaces include first interfaces associated with a first version of the plurality of versions, and second interfaces associated with a second version of the plurality of versions; and
examining interface differences between the first and second interfaces by comparing the first interfaces with the second interfaces.

2. The computer-implemented method of claim 1, wherein the interfaces further include application programming interfaces (APIs).

3. The computer-implemented method of claim 1, further comprising determining whether the interface differences include intended interface differences or unintended interface differences.

4. The computer-implemented method of claim 3, further comprising correcting, at a provider, the unintended interface differences prior to sending the first version of the software program to a customer, wherein the first version includes an unreleased version of the software program, wherein the second version include a previously released version.

5. The computer-implemented method of claim 3, further comprising maintaining the intended interface differences, and sending notifications of the intended interface differences to the customer.

6. The computer-implemented method of claim 1, wherein the binary files comprise interface provisioning details and interface usage details, wherein the interface provisioning and usage details are used to form the support criteria for the shared libraries.

7. The computer-implemented method of claim 1, further comprising generating a report listing the interface differences.

8. The computer-implemented method of claim 1, wherein the interfaces correspond to operating system functions associated with the shared libraries, wherein the operating system functions relate to one or more of file accesses, networking capabilities, user interface functions, thread management, process management, and common utilities.

9. A system comprising:
a host computing device having a memory to store instructions for managing interface differences, and a processing device to execute the instructions, wherein the instructions cause the processing device to:
extract binary files relating to a plurality of versions of a software program, wherein the binary files include support criteria associated with shared libraries used by the plurality of versions of the software program;
detect interfaces associated with the shared libraries, wherein detecting is performed by probing the binary files, wherein the interfaces include application binary interfaces (ABIs);
mark the detected interfaces based on their corresponding support criteria, wherein the interfaces include first interfaces associated with a first version of the plurality of versions, and second interfaces associated with a second version of the plurality of versions; and
examine interface differences between the first and second interfaces by comparing the first interfaces with the second interfaces.

10. The system of claim 9, wherein the interfaces further include application programming interfaces (APIs).

11. The system of claim 9, wherein the processing device is further to determine whether the interface differences include intended interface differences or unintended interface differences.

12. The system of claim 11, wherein the processing device is further to correct, at a provider, the unintended interface differences prior to sending the first version of the software program to a customer, wherein the first version includes an unreleased version of the software program, wherein the second version include a previously released version.

13. The system of claim 11, wherein the processing device is further to maintain the intended interface differences, and sending notifications of the intended interface differences to the customer.

14. The system of claim 9, wherein the binary files comprise interface provisioning details and interface usage details, wherein the interface provisioning and usage details are used to form the support criteria for the shared libraries.

15. A non-transitory machine-readable medium including instructions that, when executed by a processing device, cause the processing device to perform a method, the method comprising:
extracting binary files relating to a plurality of versions of a software program, wherein the binary files include support criteria associated with shared libraries used by the plurality of versions of the software program;
detecting interfaces associated with the shared libraries, wherein detecting is performed by probing the binary files, wherein the interfaces include application binary interfaces (ABIs);
marking the detected interfaces based on their corresponding support criteria, wherein the interfaces include first interfaces associated with a first version of the plurality of versions, and second interfaces associated with a second version of the plurality of versions; and
examining interface differences between the first and second interfaces by comparing the first interfaces with the second interfaces.

16. The non-transitory machine-readable medium of claim 15, wherein the interfaces further include application programming interfaces (APIs).

17. The non-transitory machine-readable medium of claim 15, wherein the method further comprises determining whether the interface differences include intended interface differences or unintended interface differences.

18. The non-transitory machine-readable medium of claim 17, wherein the method further comprises correcting, at a provider, the unintended interface differences prior to sending the first version of the software program to a customer, wherein the first version includes an unreleased version of the software program, wherein the second version include a previously released version.

19. The non-transitory machine-readable medium of claim 17, wherein the method further comprises maintaining the intended interface differences, and sending notifications of the intended interface differences to the customer.

20. The non-transitory machine-readable medium of claim 15, wherein the binary files comprise interface provisioning details and interface usage details, wherein the interface provisioning and usage details are used to form the support criteria for the shared libraries.
